(19) United States
(12) Patent Application Publication
(10) Pub. No.: US 2018/0172583 A1
(43) Pub. Date: Jun. 21, 2018

(54) The Calculation Method of Wave Reflective Index on Interface

(71) Applicant: Dalian Tiandao Marine Technology Co., Ltd., Liaoning (CN)

(72) Inventors: Jianxue Zhang, Liaoning (CN); Lin Jiao, Liaoning (CN); Yonggang Zhang, Liaoning (CN)

(21) Appl. No.: 15/552,142

(22) PCT Filed: Sep. 9, 2015
(86) PCT No.: PCT/CN2015/089237

§ 371 Date: Aug. 18, 2017

(51) Int. Cl. G01N 21/43; G01S 7/539; G01N 21/84

(52) U.S. Cl. CPC G01N 21/43; G01N 2021/437; G01N 21/84; G01S 7/539

(57) ABSTRACT

This disclosure provides calculation methods for the reflectivity of normal incident wave on the interface, the absolute reflection critical angle of the wave, the relative reflection critical angle of the wave, and the refraction-reflection symmetrical angle of the wave. These calculation methods can calculate the reflected wave energy on interface, the angle at which the incident wave would all be reflected on the interface and wave energy would be trapped, the angle at which the incident wave begins to be reflected, and the angle at which the reflected wave energy equals the refracted wave energy. The provided calculation methods could be widely used in various fields such as light, electromagnetic waves, sound waves and etc.

### TECHNICAL FIELD

The disclosure relates to both classic optical waveguide calculation and basic wave theory application. The methods of this disclosure will be widely used for waves transmitting through the interface in various fields, such as light, electromagnetic waves, sound waves, water waves and so on, and for waveguide calculation.

### BACKGROUND

### About Problem in Reflectivity Calculating

According to classic Fresnel equation, it has been calculated that reflectivity on water is 2% and reflectivity on glass is 4% in normal, but it has a big difference from the reality. The disclosure provides a wave reflectivity calculation method for normal incident wave on interface to solve the problem that the calculated reflectivity value is too small.

### About Problem in Reflection Critical Angle Calculating

There exists a defect when calculating reflection critical angle with Snell's law, because wave propagation from the air to the matter with reflection critical angle problem cannot be calculated with just Snell's law. Since now people have no other good ways to solve this problem, this disclosure provides a method to solve the practical problem.

When calculating reflection critical angle with the Snell's law in tradition, it requires that the angle of refraction is 90°, and the angle of incidence out of substance at this time is the reflection critical angle. Therefore, the light wave passed into substance has no reflection critical angle, and all the wave energy can be refracted into substance. The concept above is wrong although it has been used many years by people. The wave refraction from water to the air can never coincide with the wave with the angle of refraction 90°, it means people in water have never seen the target or the ship on the sea.

The question was presented 20 years before, when the inventor engaged in marine engineering calculations, who found that the wave was reflected besides the waterway then superposed and piled up with incident wave before the bulwark, and formed an unusual large wave, when the angle between the direction of incident wave and the waterway is too small. Meanwhile the wave in waterway will be reflected and stacked on the other side of the waterway too. Therefore the phenomenon of the reflecting and stacking of wave will always exist, no matter the wave travels from shallow water to deep water or from deep water to shallow water.

In the research of atmosphere waveguide soon after, when the temperature inversion layer appears in the stable stratification structure of atmosphere, it is found that, when the ship radar emits the electromagnetic wave in parallel to the horizontal plane, the electromagnetic wave would intersect with the interface of temperature inversion layer in a very small angle (about 0.1°) because of the curvature of the earth, and would be reflected back to the sea. With this phenomenon, the radar on the ship can probe the target out of horizon, and this is the waveguide effect. The waveguide is formed when electromagnetic wave travels from low-temperature air layer to high-temperature air layer, and the mirage in desert is caused by the waveguide formed when light wave travels from high-temperature air layer to low-temperature air layer.

For the sound wave propagation in the ocean, there exists similar phenomenon of both ocean acoustic waveguide and dead zone. When seasonal thermocline appears at the coastal area due to cold water mass in China Yellow Sea and Bohai Sea in summer, because of the thermocline, the sonar on the surface ship is hard to probe the target which is at a few hundred meters away under the thermocline water. The underwater sonar or the hydrophone is also hard to probe the sound of ship in a few hundred meters away. The distance has a big difference from the rated detection distance 10-20 km by sonar.

Whatever water wave or electromagnetic wave or sound wave, if there's wave travel speed difference existing at the interface, even if the difference is very small, reflected wave will appear when the angle between the incident wave and the interface is small enough, which has been proved by experiments. No matter the wave travels from the media with high wave velocity to the media with low wave velocity or reverse, the reflection critical angle always exists.

And for wave, as long as the angle between the incident wave and the interface is small enough, the rebound wave of “stone skimming effect” exists on both sides of the interface. And reflective region is divided into both absolute reflection region and relative reflection region.

### SUMMARY

Method for Calculating the Reflected Wave by Dividing Wavelength into Three Sections

When the normal component of wavelength of incident wave on interface (or m times the wavelength) equals a quarter of wavelength of refracted wave in the medium, the incident wave energy would be all reflected. Similarly, when the wavelength of normal incident wave is compressed to a quarter of wavelength of refracted wave in the medium, the incident wave energy would be all reflected (or trapped).

When the normal component of wavelength of incident wave on interface (or m times the wavelength) equals a half of wavelength of refracted wave in the medium, a half of the incident wave energy would be reflected. Similarly, when the wavelength of normal incident wave is compressed to a half of wavelength of refracted wave in the medium, a half of the incident wave energy would be reflected.

When the normal component of wavelength of incident wave on interface (or m times the wavelength) equals resonance wavelength near three quarters of wavelength of refracted wave in the medium, the incident wave energy would begin to be reflected. Similarly, when the wavelength of normal incident wave is compressed to resonance wavelength near three quarters of wavelength of refracted wave in the medium, the incident wave energy would begin to be reflected.

### BRIEF DESCRIPTION OF THE DRAWINGS

For a more complete understanding of the present disclosure, and the advantages thereof, reference is now made to the following description taken in conjunction with the accompanying drawings, in which like numbers designate like parts, and in which:

FIG. 1 shows the relationship between the reflectivity on interface and compressed wavelength;

FIG. 2 shows the phenomenon of light waves travelling from water into air;

FIG. 3 shows the phenomenon of light waves travelling from air into water;

FIG. 4 shows the application of ocean acoustic waveguide.

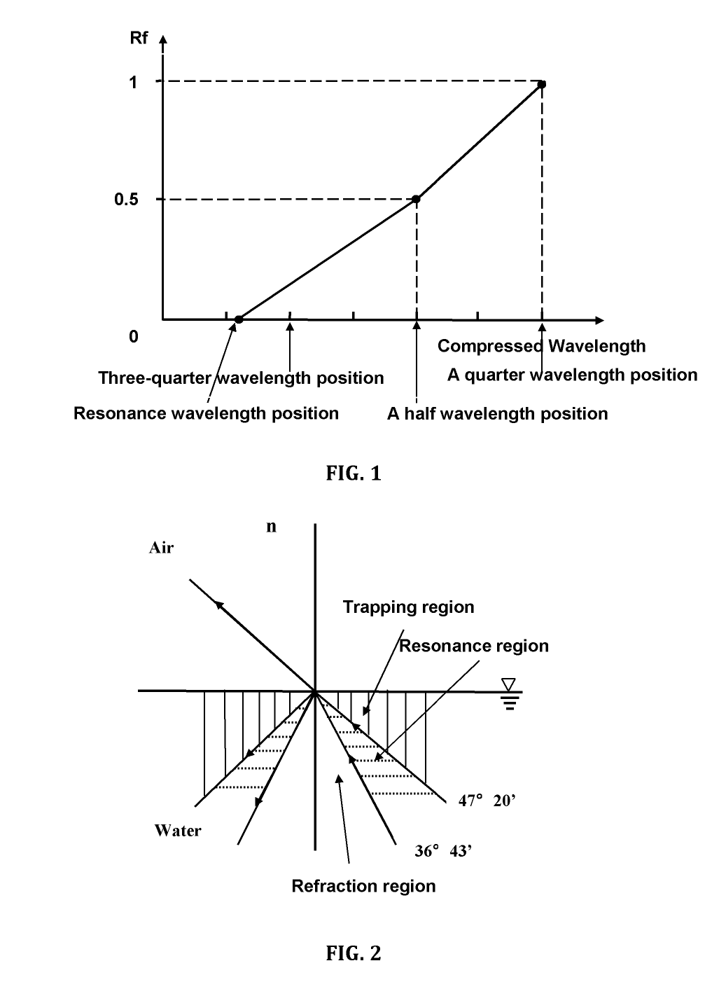

### DETAILED DESCRIPTION

### 1. the Method for Calculating Absolute Reflection Critical Angle

When the wave speeds difference of both sides of the interface is small and refractivity is close to 1, normal component of wavelength of incident wave can't satisfy a quarter of wavelength of refracted wave in the medium, and a method for solving the question is needed. Following Stem wave study, the inventor has been enlightened.

### Absolute Reflection Critical Angle Calculation Method:

When the refractivity n fulfills

$$n = \frac{{c}_{in}}{{c}_{refra}} \leq 1.25 ,$$

if the normal component of m times the wavelength of incident wave on interface equals a quarter of wavelength of refracted wave in the medium, the incident wave energy would be all reflected. The angle is absolute reflection critical angle in weak interface. According to the expression

$$m \cdot {c}_{in} cos {θ}_{in} = \frac{1}{4} {c}_{refra} ,$$

the formula of the absolute reflection critical angle is

$$cos {θ}_{abs} = \frac{0.25}{mn} ,$$

wherein coefficient of wave individual number m is an integer. Due to

$$n - 1 = \frac{{c}_{in} - {c}_{refra}}{{c}_{in}} = \frac{0.25}{m} , m = [ \frac{0.25}{n - 1} ] .$$

It is also called generalized quarter wavelength reflection critical angle calculation method.

When the coefficient of wave individual number m=1, i.e. the refractivity n fulfills

$$n = \frac{{c}_{in}}{{c}_{refra}} \geq 1.25 ,$$

if the normal component of incident wave velocity on the interface equals a quarter of refracted wave velocity in the medium, the incident wave energy would be all reflected. The angle is absolute reflection critical angle. According to the expression

$${c}_{in} cos {θ}_{in} = \frac{1}{4} {c}_{refra} ,$$

the formula of the absolute reflection critical angle is

$$cos {θ}_{abs} = \frac{0.25}{n} ;$$

wherein the cᵢₙ is the incident wave velocity; the c_{refra} is the refracted wave velocity; and the θ_{abs} is the absolute reflection critical angle. It is also called a quarter wavelength critical angle calculation method.

The condition for applying this calculating method is that the incident wave propagates from high wave velocity medium to low wave velocity medium, which means refry cᵢₙ>c_{refra}. Through calculating by this method, we could get the absolute reflection critical angle on side of high wave velocity medium (e.g. air).

If it is desired to calculate the absolute reflection critical angle of low wave velocity media (e.g. substance), the absolute reflection critical angle of the high wave velocity media could be calculated first by the method in this disclosure, and afterwards the absolute reflection critical angle of low wave velocity media could be calculated by Snell's law with using the reversibility of wave.

When n=1.25, the absolute reflection critical angle is smallest, and the value is 78°27, which means the angle between the interface and the incident wave is largest, and the value is 11°33′. When n=4, the value of absolute reflection critical angle is 88°25′, and we can get that the value of the absolute reflection critical angle of wave which passes out of the material is 14°29′ by the Snell's law. And this result is almost same as the result calculated by the Snell's law when the angle of refraction is 90°.

When n=1.0063, meanwhile m=40, the value of absolute reflection critical angle is 89°38′, close to 90°.

### Detailed Description of Cases of Absolute Reflection Critical Angle Calculation

This method can be verified by the experiment of light travelling from the air into the water. By this method, it can be calculated that the value of absolute reflection critical angle on water is 79°10′. With equipment used in the physics experiment in the middle school, it could be verified that total reflection would occur when light waves pass into the water at some angle between 79° and 80°. When the angle of incidence of light passing into water varies from 79° to 80°, the pattern of light wave in the water would suddenly disappear, without any trace.

Now we compare the critical angle calculated by the Snell's law (when the angle of refraction is 90°) and the critical angle calculated by this method to illustrate rationality of the method in this disclosure. See the table 1 below.

TABLE 1
listing and comparing the critical angels calculated by two methods under different refractivities

| | Medium | | | | | | | | |
|---|---|---|---|---|---|---|---|---|---|
| | m = 3 | m = 2 | m = 1 | Ice | Water | glycerin | glass | crystal | Diamond |
| Refractivity (n) | 1.083 | 1.125 | 1.25 | 1.309 | 1.333 | 1.473 | 1.5 | 2 | 2.417 |
| Critical angle when | 67°23 | 62°44 | 53°08 | 49°49\grave{ } | 48°36\grave{ } | 42°42\grave{ } | 42° | 30° | 24°24\grave{ } |
| passing out of the | | | | | | | | | |
| medium, calculated | | | | | | | | | |
| by Snell's law | | | | | | | | | |
| Critical angle when | 67°00 | 62°06 | 51°27 | 48°34\grave{ } | 47°20\grave{ } | 42° | 41°10\grave{ } | 29°45\grave{ } | 24°17\grave{ } |
| passing out of the | | | | | | | | | |
| medium, calculated | | | | | | | | | |
| by the method in | | | | | | | | | |
| this disclosure | | | | | | | | | |

It could be derived from table 1 that there's little difference between the results of these two calculating methods, and when n=1.25, m=1, we got the largest difference value of 1°41′. It shows that this method and Snell's law with extreme conditions (non-existent) is close in the calculated results, which has proved this method has its rationality and practicability. At least the calculated result by this method is closer to the real objective facts.

It has also proved that the value of critical angle calculated by Snell's law is close to real threshold, and that's the reason why there has no person to put forward any objection when the Snell's law has been used widely in the past 300 years. But just because of this little difference, there exists a reflection critical angle when the light wave passes from the air into substance, and not all of the light wave energy can be refracted into substance.

### 2. The Method for Calculating Relative (or Resonance) Reflection Critical Angle

When the wave speeds difference of both sides of the interface is small and refractivity is close to 1, normal component of wavelength of incident wave can't satisfy a quarter of the wavelength of refracted wave in the medium.

### Resonance Critical Angle Calculation Method:

When refractivity of the wave fulfills

$$n = \frac{{c}_{in}}{{c}_{refra}} \leq 1.25 ,$$

the normal component of m times the wavelength of incident wave on interface takes part in resonating, the wave begins to resonate in the interface, and the angle of incidence at this moment is relative reflection critical angle. The calculation method is

$$tg {θ}_{resonance} = n \sqrt{\frac{{m}^{2} {n}^{2} - 1}{{n}^{2} - 1}} .$$

Coefficient of wave individual number m is an integer, due to

$$n - 1 = \frac{{c}_{in} - {c}_{refra}}{{c}_{in}} = \frac{0.25}{m} , m = [ \frac{0.25}{n - 1} ] .$$

The θ_{resonance} is the relative reflection critical angle of the wave.

Proof: any wave passing through interface of the medium follows the Snell's law, and the resonant wave on interface follows that the normal component of m times the wave velocity of incident wave equals the normal component of the wave velocity of refracted wave. It could be expressed by two equations

$$\frac{sin {θ}_{in}}{{c}_{in}} = \frac{sin {θ}_{refra}}{{c}_{refra}}$$

and mcᵢₙ cos θᵢₙ=c_{refra} cos θ_{refra}. By combining the two equations to eliminate the terms regarding the refracted wave,

$$tg {θ}_{resonance} = n \sqrt{\frac{{m}^{2} {n}^{2} - 1}{{n}^{2} - 1}}$$

could be obtained. This completes the proof.

The method can calculate the relative reflection critical angles of both sides of the interface in nature. This method is also known as generalized resonance critical angle calculation method.

When the coefficient of wave individual number m=1, i.e. n≥1.25, the calculating method for resonance reflection critical angle when wave begins to be reflected is tgθ_{resonance}=n, and this is called resonance critical angle calculation method.

### The Calculation Method for Ultra Weak Interface

For ultra weak interface waveguide, m=8, n=1.0313, its absolute critical angle is 88°16′, and relative critical angle is 88°17′, and the value of relative critical angle is just more than the value of absolute critical angle. For the ultra weak interface (n≤1.0313), we could neglect the existence of relative critical angle, and only calculate absolute critical angle.

### Detailed Description of Cases of Absolute and Relative Reflection Critical Angles Calculation

TABLE 2
listing and comparing the absolute and relative reflection critical angles calculated by two methods in
this disclosure under different refractivities

| | Medium | | | | | | | |
|---|---|---|---|---|---|---|---|---|
| | m = 2 | m = 1 | Ice | Water | Glass | Crystal | Diamond | m = 1 |
| refractivity (n) | 1.125 | 1.25 | 1.309 | 1.333 | 1.5 | 2 | 2.417 | 4 |
| Absolute reflection critical angle | 62°03 | 51°27 | 48°34\grave{ } | 47°20\grave{ } | 41°10\grave{ } | 29°45\grave{ } | 24°17\grave{ } | 14°29 |
| when passing out of the medium | | | | | | | | |
| Relative reflection critical angle | 60°33 | 38°40 | 37°17 | 36°43 | 33°42 | 26°34 | 22°29 | 14°04 |
| when passing out of the medium | | | | | | | | |
| Difference between absolute and | 1°30 | 12°47 | 11°17 | 10°37 | 7°28 | 3°11 | 1°48 | 0°25 |
| relative reflection critical angles | | | | | | | | |
| when passing out of the medium | | | | | | | | |
| Absolute reflection critical angle | 83°33 | 78°27 | 79° | 79°10\grave{ } | 80°40\grave{ } | 82°49\grave{ } | 83°40\grave{ } | 88°25 |
| when passing into the medium | | | | | | | | |
| Relative reflection critical angle | 78°24 | 51°21 | 52°27 | 52°50 | 56°29 | 63°26 | 67°30 | 85°35 |
| when passing into the medium | | | | | | | | |
| Difference between absolute and | 5°18 | 27°06 | 26°33 | 26°20 | 24°11 | 19°23 | 16°10 | 2°50 |
| relative reflection critical angles | | | | | | | | |
| when passing into the medium | | | | | | | | |

It could be derived from table 2 that, when the wave passes out of the medium, absolute and relative reflection critical angles are reducing while the refractivity is increasing. The difference value shows an inflection point at the time when the refractivity is 1.25. When passing into the medium, the absolute and relative reflection critical angles show an inflection point at the time when the refractivity is 1.25, and the difference value between both the angles reaches its maximum value in refractivity 1.25. This shows, from the inflection point, no matter the refractivity increases or decreases, the two critical angles show similar tendencies, and when the refractivity increases or decreases up to a certain value, the two critical angles are close to each other.

### 3. The Calculation Method for Refraction-Reflection Symmetry Angle

When the refractivity fulfills

$$n = \frac{{c}_{in}}{{c}_{refra}} \leq 1.25 ,$$

if the normal component of m times the wavelength of incident wave on interface equals a half of wavelength of refracted wave in the medium, the angle of incidence at this moment is wave energy symmetry reflection critical angle in weak interface. According to the expression

$$m \cdot {c}_{in} cos {θ}_{in} = \frac{1}{2} {c}_{refra} ,$$

the calculation method is

$$cos {θ}_{sym} = \frac{0.5}{mn} ,$$

wherein the refractivity

$$n = \frac{{c}_{in}}{{c}_{refra}} \leq 1.25 ,$$

the coefficient of wave individual number m is an integer. Due to

$$n - 1 = \frac{{c}_{in} - {c}_{refra}}{{c}_{in}} = \frac{0.25}{m} , m = [ \frac{0.25}{n - 1} ] .$$

It is called generalized refraction-reflection wave energy symmetry angle calculation method or inflection point calculation method.

When the coefficient of wave individual number m=1, i.e. the refractivity n fulfills

$$n = \frac{{c}_{in}}{{c}_{refra}} \geq 1.25 ,$$

if the normal component of wave velocity of incident wave on the interface equals a half of wave velocity of refracted wave in the medium, then the reflected wave energy at this moment equals the refracted wave energy. According to

$${c}_{in} cos {θ}_{in} = \frac{1}{2} {c}_{refra} ,$$

the calculation method is

$$cos {θ}_{sym} = \frac{0.5}{n} .$$

This method is also known as refraction-reflection wave energy symmetry angle calculation method.

### 4. The Methods for Calculating Reflectivity of Normal Incident Wave on Interface

### 4.1 Wave Resonance Coefficient Calculation Method

In accordance with the expressions of both absolute reflection critical angle and refraction-reflection wave energy symmetry angle, resonance critical angle can be expressed by

$$cos {θ}_{resonance} = ( \frac{3}{4} + \frac{{z}_{h}}{16} ) \frac{1}{n} .$$

Because of the known relative reflection critical angle calculation method tgθ_{resonance}=n, resonance coefficient zₕ could be determined by zₕ=16(n cos(arctg(n))−0.75).

### 4.2 Calculation Method of Reflectivity of the Wave

It is assumed that the reflectivity of the wave has presented a linear increase from the value of zero to the value of 0.5, when the wavelength increases from resonance wavelength position to a half wavelength position.

When the refractivity n of the wave fulfills 2≥n≥1, the reflectivity R_{f} of the wave could be expressed by:

$${R}_{f} = \frac{1}{2} \frac{( 1 - \frac{1}{n} ) - ( 0.25 - \frac{{z}_{h}}{16} )}{0.25 + \frac{{z}_{h}}{16}} .$$

When R_{f}=0, it can be calculated that n=1.2961. When the refractivity n of the wave fulfills n≤1.2961, wave energy has no reflection in normal incident wave on interface and the wave would be transmitted through the interface and be refracted in medium.

It is assumed that the reflectivity of the wave has presented a linear increase from the value of 0.5 to the value of 1, when the wavelength increases from a half wavelength position to a quarter wavelength position.

When the refractivity n of the wave fulfills 4≥n≥2, the reflectivity R_{f} of the wave could be expressed by:

$${R}_{f} = 0.5 + \frac{0.5 - \frac{1}{n}}{0.5} .$$

When the refractivity n of the wave fulfills n≥4, the reflectivity R_{f} of the wave could be expressed by R_{f}=1.

TABLE
showing that wave reflectivity calculated by the method changes as the refractivity changes for common substances

| Medium | Ice | Water | Alcohol | Glycerin | Glass | Tremolite | Chalybite | Crystal | Diamond |
|---|---|---|---|---|---|---|---|---|---|
| Refractivity (n) | 1.309 | 1.333 | 1.36 | 1.473 | 1.5 | 1.6 | 1.63 | 2 | 2.417 |
| Resonance coefficient: zₕ | 0.779 | 0.88 | 0.8832 | 1.2928 | 1.299 | 1.579 | 1.627 | 2.3168 | 2.788 |
| Resonance wavelength: | 3.194/4 | 3.22/4 | 3.2208/4 | 3.3232/4 | 3.3248/4 | 3.3948/4 | 3.4068/4 | 3.5792/4 | 3.69/4 |
| ${L}_{resonance} = ( \frac{3}{4} + \frac{{z}_{h}}{16} )$ | | | | | | | | | |
| Wave reflectivity: R_{f} | 0.06 | 0.09 | 0.1147 | 0.23 | 0.25 | 0.3308 | 0.3379 | 0.5 | 0.605 |

As shown in table 3, along with the increasing of the refractivity (n), the values of both resonance coefficient and wave reflectivity increase.

### About Technical Effect of Reflectivity Calculating Method

By the classic Fresnel equation, it has been calculated that the reflectivity on water is only 2% and the reflectivity on glass is only 4% in normal on interface. These values are too small and have a big difference from the reality. The wave reflectivity calculation method we proposed in the disclosure has solved the problem. By the proposed calculation method, it is calculated that the reflectivity on water is 9% and the reflectivity on glass is 25% in normal on interface.

### About Technical Effect of Reflection Critical Angle Calculating Method

The methods for calculating absolute and relative reflection critical angles proposed in the disclosure may calculate not only the angles when the wave passes out of the medium, but also the angles when the wave passes into the medium. While, the angles when the wave passes into the medium cannot be calculated by Snell's law.

The rationality of the method in this disclosure could be proved by comparing the critical angle calculated by the Snell's law (when the angle of refraction is 90°) and that calculated by the absolute reflection critical angle method when the wave passes out of the medium. There's little differences between the results of these two methods. It shows that this method and Snell's law with extreme conditions (non-existent) is close in the calculated results, which has proved that this method has its rationality and practicability. At least the calculated results of this method are closer to the real objective facts. This has also proved that the value of critical angle calculated by Snell's law is close to real threshold, and that's the reason why there has no person to put forward any objection when the Snell's law has been used widely in the past 300 years. But just because of this little difference, there exists a reflection critical angle when the light wave passes from the air into substance, and not all parts of the light wave energy can be refracted into substance.

### Examples for Applying the Proposed Methods

### Example 1

The phenomenon of light waves travelling from water to air is shown in FIG. 2.

When m=1, and n=1.3333, if the angle of incidence of wave in water is less than 36°43′, all the parts of wave energy can pass through the interface and then be refracted to the air.

When the angle of incidence of wave in water is between 36°43′ and 47°20′, it falls into the resonance region, at this moment the light wave energy has been separated, some energy of wave has been reflected back to water and some has been refracted to the air. Along with the increase of the angle of incidence, the energy of reflected wave increases linearly until total reflection occurs when the angle of incidence is 47°20′.

When the angle of incidence in water is larger than 47°20′, the light energy will be all reflected back and be trapped in the water.

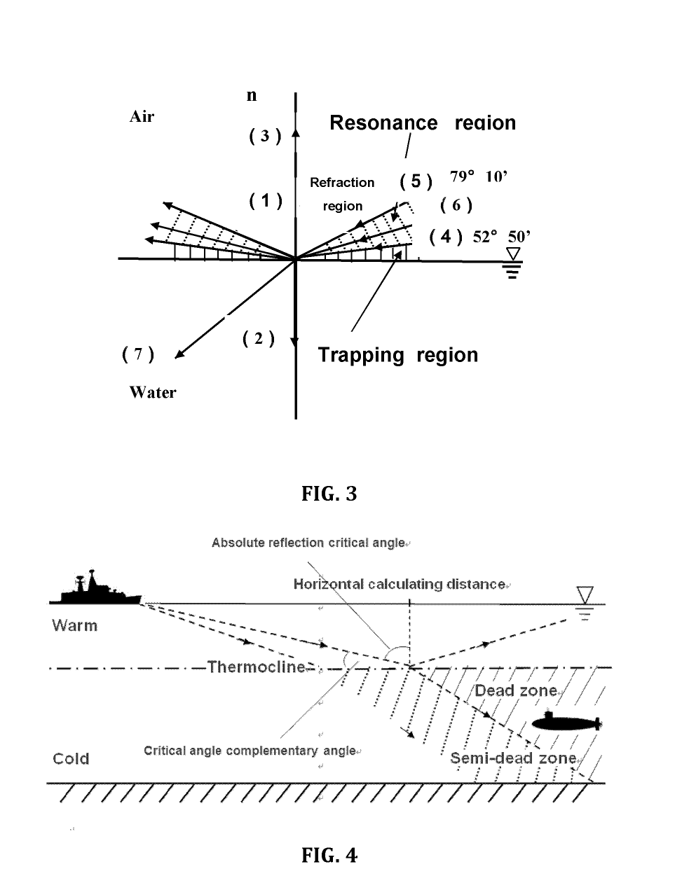

The phenomenon of light waves travelling from air to water is shown in FIG. 3.

By the methods, when m=1, and n=1.3333, if the angle of incidence of wave in air is less than 52°50′, all the parts of wave energy can pass through the interface and then be refracted to the water.

When the angle of incidence of wave in air is between 52°50′ and 79°10′, it falls into the resonance region, at this moment the light wave energy has been separated, some energy of wave has been reflected back to air and some has been refracted to the water. Along with the increase of the angle of incidence, the energy of reflected wave increases linearly until total reflection occurs when the angle is 79°10′.

When the angle of incidence in air is larger than 79°10′, the light energy will be all reflected back and be trapped in the air.

As can be seen from the above, when the waveguide phenomenon occurs in any interface or transition zone, there are two trapping area, one is an absolute wave energy trapping area, the other is a relative or partial wave energy trapping area. The amount of trapped wave energy can depend on the relationship between the critical angle and resonance angle.

### Example 2

The application of ocean acoustic waveguide is shown in FIG. 4.

In China Yellow Sea and Bohai Sea, there exists a cold water mass at depths of more than 50 meters in the summer, and along with the cold water mass, there occurs the seasonal thermocline.

Test area is in the vicinity of 124E, 38N. In mid-august, the water above the thermocline layer is warm water with T=24 (° C.)., depth of water is 5 meters, the water under the thermocline layer is cold water with T=8 (° C.)., and depth of water is 45 meters. By applying the formula proposed in Mackenzie (1981), it can be calculated that the ratio of the sound velocity in the water above the thermocline layer to the sound velocity in the water under the thermocline layer is:

$$n = \frac{{c}_{up}}{{c}_{under}} = 1.05 .$$

It can be further calculated that m=5. So, if detecting the underwater target from the ship, the absolute reflection critical angle is 87°16′, and the relative reflection critical angle is 86°37, as calculated by the methods. For the absolute reflection, the angle between the sound ray emitted from the sonar on the ship and the interface of the thermocline layer is 02°44′, and for the relative reflection, the angle between the sound ray and the interface is 03°23′. The tangents of the two angles are 0.04774 and 0.05912 respectively. The actual distance from the thermocline layer to the sea surface is 25 meters, and thus the corresponding horizontal distances are 523.67 meters and 422.87 meters respectively. This means when the horizontal distance from ship to underwater target is less than 423 meters, the target can be detected clearly; the target signal would be weaken gradually when the distance increases from 423 meters to 524 meters; and the target signal would be totally lost when the distance is more than 524 meters. According to the actual measurement results in the sea, when the distance reaches 500 meters, the signal is weaken obviously, and when the distance is about 600 meters, the signal from underwater target is all lost. The theoretial calculation and the actual measurement matches very well. The inventor has conducted such measurements many times. In the above mentioned sea area, the largest detection distance for underwater target is no more than one kilometer in summer, and most of the test data and the theoretial calculation in this disclosure are in good agreement.

If using historical monthly average data such as WOA13 instead of the actually measured thermocline strength, the error rate on the horizontal distance is within 40-50%. This fully shows the practicability of the methods in the disclosure.

If we do not need consider the influence of the thermocline on sound propagation, for example in winter when the thermocline disappears usually, the detection distance of the sonar on ship sailling on the sea surface is more than 10 kilometers. If we need consider the influence of the thermocline on sound propagation, for example in summer, without the method in this disclosure, the critical angle of the incident wave from the upper warm water into the lower cold water cannot be calculated using the Snell's law. However, the calculation method in this disclosure could be applied to calculate the critical angle of the incident wave from high wave velocity medium to low wave velocity medium. Although the critical angle is small, it plays an important role, and could decide the detection distance of the sonar on the ship in the presence of thermocline. As can be seen from this case, there exists a strong demand for antisubmarine detection from surface ships and for underwater target search, and we need propose solutions for this kind of realistic and difficult problems.

### Example 3—Anti-Reflection Coating

When the refractivity n of the wave fulfills 2≥n≥1, the reflectivity R_{f} of the wave could be expressed by:

$${R}_{f} = \frac{1}{2} \frac{( 1 - \frac{1}{n} ) - ( 0.25 - \frac{{z}_{h}}{16} )}{0.25 + \frac{{z}_{h}}{16}} .$$

When R_{f}=0, could be calculated that n=1.2961. When the refractivity of the wave fulfills n≤1.2961, wave energy has no reflection in normal incident wave on interface and the wave would be transmitted through the interface and be refracted in medium.

The refractivity from the anti-reflection coating to the glass may be expressed by:

$${n}^{1} = \frac{{n}_{glass}}{{n}_{coating}} .$$

When R_{f}=0, it could be calculated that n¹=1.2961, and therefore n_{coating}=1.1574

When 1.1574≤n_{coating}≤1.2961, no reflection of wave energy would appear.

The average value is:

$$\frac{1.1574 + 1.2961}{2} = 1.2268 .$$

The best refractivity of the anti-reflection coating is 1.2268, for that there is no reflection of wave energy. The result almost has no difference from the known refractivity 1.225 obtained from the test data.

1. A method for calculating a reflectivity of wave at an interface, comprising:
when a refractivity n of the wave at the interface fulfills 2≥n≥1, calculating a reflectivity R_{f} of normal incident wave at the interface by
$${R}_{f} = \frac{1}{2} \frac{( 1 - \frac{1}{n} ) - ( 0.25 - \frac{{z}_{h}}{16} )}{0.25 + \frac{{z}_{h}}{16}} ,$$
wherein Zₕ is a resonance coefficient,
when the refractivity n fulfills 4≥n≥2, calculating the reflectivity R_{f} of normal incident wave at the interface by
$${r}_{f} = 0.5 + \frac{0.5 - \frac{1}{n}}{0.5} ,$$
when the refractivity n fulfills n≥4, calculating the reflectivity R_{f} of normal incident wave at the interface by
R_{f}=1,
wherein incident wave energy is all reflected.

2. The method of claim 1, further comprising calculating the resonance coefficient Zₕ by
zₕ=16(n cos(arctg(n))−0.75), which is obtained by combining equations as follows:
$$\frac{cos {θ}_{resonance} = ( \frac{3}{4} + \frac{{z}_{h}}{16} ) \frac{1}{n}}{tg {θ}_{resonance} = n} ,$$
wherein the first equation is obtained in accordance with expressions of both an absolute reflection critical angle and a refraction reflection symmetry angle form of the incident wave.

3. The method of claim 2, further comprising when the wave passes from a medium with higher wave velocity to a medium with lower wave velocity,
if the refractivity n fulfills the following condition
$$n = \frac{{c}_{in}}{{c}_{refra}} \leq 1.25 ,$$
then calculating the absolute reflection critical angle θ_{abs} of the wave by
$$cos {θ}_{abs} = \frac{0.25}{mn} ,$$
wherein a coefficient of wave individual number m is an integer, and is obtained by
$$m = [ \frac{0.25}{n - 1} ] ,$$
which is deduced by
$$n - 1 = \frac{{c}_{in} - {c}_{refra}}{{c}_{in}} = \frac{0.25}{m} ,$$
if the refractivity n fulfills the following condition, and thus the coefficient of wave individual number m is 1,
$$n = \frac{{c}_{in}}{{c}_{refra}} \geq 1.25 ,$$
then calculating the absolute reflection critical angle θ_{abs} of the wave by
$$cos {θ}_{abs} = \frac{0.25}{n} ,$$
when the wave passes from a medium with lower wave velocity to a medium with higher wave velocity, calculating the absolute reflection critical angle of the medium with higher wave velocity by the method described above first, and then calculating the absolute reflection critical angle of the medium with lower wave velocity by using Snell's law with using the reversibility of wave.

4. The method of claim 2, further comprising:
if the refractivity n fulfills the following condition
$$n = \frac{{c}_{in}}{{c}_{refra}} \leq 1.25 ,$$
then calculating a resonance reflection critical Angle θ_{resonance} by
$$tg {θ}_{resonance} = n \sqrt{\frac{{m}^{2} {n}^{2} - 1}{{n}^{2} - 1}} ,$$
wherein a coefficient of wave individual number m is an integer, and is obtained by
$$m = [ \frac{0.25}{n - 1} ] ,$$
which is deduced by
$$n - 1 = \frac{{c}_{in} - {c}_{refra}}{{c}_{in}} = \frac{0.25}{m} ,$$
if the refractivity n fulfills the following condition, and thus the coefficient of wave individual number m is 1,
$$n = \frac{{c}_{in}}{{c}_{refra}} \geq 1.25 ,$$
then calculating the resonance reflection critical angle θ_{resonance} by tgθ_{resonance}=n.

5. The method of claim 2, further comprising:
if the refractivity n fulfills the following condition
$$n = \frac{{c}_{in}}{{c}_{refra}} \leq 1.25 ,$$
then calculating the refraction-reflection symmetry angle θ_{sym} by
$$cos {θ}_{sym} = \frac{0.5}{mn} ,$$
wherein a coefficient of wave individual number m is an integer, and is obtained by
$$m = [ \frac{0.25}{n - 1} ] ,$$
which is deduced by
$$n - 1 = \frac{{c}_{in} - {c}_{refra}}{{c}_{in}} = \frac{0.25}{m} ,$$
if the refractivity n fulfills the following condition, and thus the coefficient of wave individual number m is 1,
$$n = \frac{{c}_{in}}{{c}_{refra}} \geq 1.25 ,$$
then calculating the refraction-reflection symmetry angle θ_{sym} by
$$cos {θ}_{sym} = \frac{0.5}{n} .$$

6. The method of claim 1, further comprising, when a normal component of wavelength of incident wave on the interface or m times the wavelength equals a quarter of wavelength of refracted wave in the medium, calculating that the incident wave energy is all reflected, wherein a coefficient of wave individual number m is an integer, and is obtained by
$$m = [ \frac{0.25}{n - 1} ] ,$$
which is deduced by
$$n - 1 = \frac{{c}_{in} - {c}_{refra}}{{c}_{in}} = \frac{0.25}{m} .$$

7. The method of claim 1, further comprising, when a normal component of wavelength of incident wave on the interface or m times the wavelength equals a half of wavelength of refracted wave in the medium, calculating that a half of the incident wave energy is reflected, wherein a coefficient of wave individual number m is an integer, and is obtained by
$$m = [ \frac{0.25}{n - 1} ] ,$$
which is deduced by
$$n - 1 = \frac{{c}_{in} - {c}_{refra}}{{c}_{in}} = \frac{0.25}{m} .$$

8. The method of claim 1, further comprising, when a normal component of wavelength of incident wave on interface or m times the wavelength equals a resonance wavelength near three quarters of wavelength of refracted wave in the medium, calculating that the incident wave energy begins to be reflected,
wherein a coefficient of wave individual number m is an integer, and is obtained by
$$m = [ \frac{0.25}{n - 1} ] ,$$
which is deduced by
$$n - 1 = \frac{{c}_{in} - {c}_{refra}}{{c}_{in}} = \frac{0.25}{m} .$$
